(19) United States
(12) Patent Application Publication
(10) Pub. No.: US 2004/0257966 A1
(43) Pub. Date: Dec. 23, 2004

(54) Reading method of an optical disk

(76) Inventor: Katsuhiko Shinohara, Kakogawa-shi (JP)

Correspondence Address: Katsuhiko Shinohara, 669-20, Kimura, Kakogawa-choo, Kakogawa-shi, Hyogo, 675-0038, JP

(21) Appl. No.: 10/846,887

(22) Filed: May 17, 2004

(30) Foreign Application Priority Data
Jan. 7, 2003 (JP) 2003-48227
Jun. 2, 2003 (JP) 2003-198785

(51) Int. Cl. G11B 7/00

(52) U.S. Cl. 369/124.12; 369/44.41; 369/44.26

(57) ABSTRACT

With the detection of a difference between both sides of a divided focus light spot of the returned light from an optical disk, the measurements obtained by means of said detection is represented as a graph having a more particular point or a sharper point than the light intensity distribution graph of the focus light spot of the returned light from the optical disk.

With three values Q, R and S from the detection of a difference between both sides of a divided focus light spot of the returned light from the optical disk, the center position of each conventional recorded mark or each pit pattern on the optical disk is obtained by the value (Q−2R+S).

### FIELD OF THE INVENTION

This invention relates to the reading method of an optical disk with the effect of minimizing the misreading of recorded information in said optical disk, caused by scratches, dust and oil from fingers on the protection layer of the recording surface of the optical disk, outfocusing of a recording focus light spot, tracking errors, laser noise for reading and amplifier noise, etc.

### BACKGROUND OF THE INVENTION

The higher NA of an objective lens for increasing recorded information in an optical disk system, the greater the coma aberration of the reading focus light spot becomes. Therefore, a high-NA objective lens requires a thin protective layer on the recording surface of the optical disk in order to decrease coma aberration, and that makes misreading of recorded information increase due to scratches and stains caused by dust or oil from fingers, etc.

Therefore, it is required that a strong error detection/correction mechanism be added to the optical disk system or that the optical disk be protected by a case and that a focusing mechanism of the reading laser beam be made more precise.

### SUMMARY OF THE INVENTION

The object of the present invention is to provide the reading method by which an optical disk system with a high-NA objective lens can minimize misreading of the recorded information in the optical disk caused by scratches, stains (e.g. dust and oil from fingers), outfocusing and tracking errors of the reading laser beam, and reading laser noise and amplifier noise.

In the reading method of said optical disk, conventional recorded marks or pit patterns on said optical disk are made round, and the returned light from the optical disk is focused on the bisected photo-detector. Then the difference in the quantity of light on the said bisected photo-detector is calculated.

The three values A, B and C of the difference in the quantity of light on respective said bisected photo-detector are obtained at regular time intervals. Then, the peak position of the value of (A−2B+C) indicates the center-position of the conventional recorded round marks or pit patterns on said optical disk.

The two differentiated values D′ and E′ of the respective two values D and E of the difference in the quantity of light on the said bisected photo-detector are obtained at regular time intervals. Then, the peak-position of the value of (D′−F′) indicates the center-position of each of the conventional recorded round marks or pit patterns on said optical disk.

### BRIEF DESCRIPTION OF THE DRAWINGS

FIG. 1. shows a diagram of an embodiment for a reading method of an optical disk.

FIG. 2. shows an illustration explaining the relationship between a conventional recorded round mark and two focus light spots of +/−1^{st} degree diffraction light to detect the position of a conventional recorded round mark on an optical disk.

FIG. 3 shows an illustration explaining the relationship between a conventional recorded round mark and a reading focus light spot on an optical disk.

FIG. 4 shows a graph of the difference in the quantity of light on the respective bisected photo-detectors.

FIG. 5 shows a differentiated graph of a section (14) in FIG. 4.

FIG. 6 shows a graph of the value (G−2H+1) obtained from the section (14) in FIG. 4 at three positions in regular order or a graph of the value of (J−K) obtained from a section (15) in FIG. 5 at two positions in regular order.

FIG. 7 shows an illustration explaining the relationship between a conventional recorded round mark and the center position of a reading focus light spot in a conventional reading method of an optical disk.

FIG. 8 shows a graph of detected reading photo-quantity fluctuation according to the locational relationship between a conventional recorded round mark and a reading focus light spot in FIG. 7.

FIG. 9 shows a light intensity distribution illustration of the image of a conventional recorded round mark focused on a bisected photo-detector when the center position of a reading focus light spot exists at that of a conventional recorded round mark on an optical disk.

### DESCRIPTION OF THE PREFERRED EMBODIMENTS

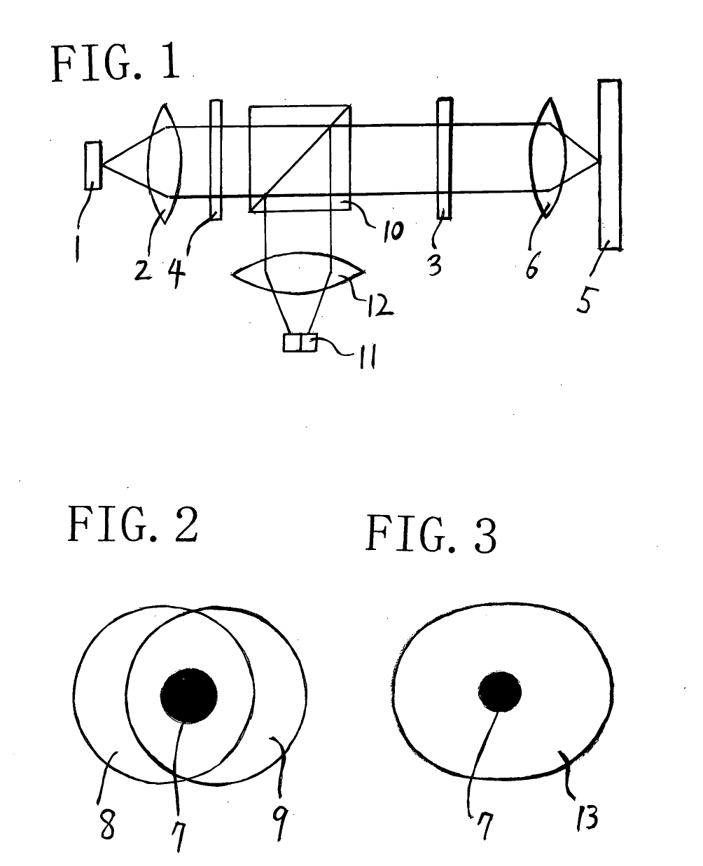

An embodiment of the present invention is explained herein after referring to the Figures. In FIG. 1, the reading laser beam emitted by a semiconductor laser source (1) is turned into parallel light using a coupling lens (2), and is passed through a quarter-wave plate (3) after passing through a diffraction grating (4) with no zero-degree diffraction light, and then is focused on the recording surface of an optical disk (5) through an objective lens (6).

The two first-degree diffraction light beams are generated when the reading laser beam passes through said diffraction grating (4).

As shown in FIG. 2, the two first-degree diffraction lights are focused on the recording surface of the optical disk (5) as two focus light spots (8) and (9) overlap each other.

A conventional recorded round mark or a pit pattern (7) on the optical disk (5) exists in the center of the overlapping area in the focus light spots (8) and (9) when the center position of the conventional recorded round mark or the pit pattern (7) is detected.

The conventional recorded round mark or the pit pattern (7) on the optical disk (5) is therefore irradiated in almost the same light intensity distribution in the direction of the recording track of the optical disk (5).

In FIG. 1, the returned light beam from the optical disk (5) is separated by a polarization beam splitter (10), positioned between the diffraction grating (4) and the quarter-wave plate (3) on the optical path, and is then focused on the bisected photo-detector (11) through an objective lens (12).

The three values D, E and F or the two values G and H obtained by means of the difference in the quantity of light on respective bisected photo-detector (11) are detected at regular time intervals. Then, the two differentiated values G′ and H′ are obtained from the respective two values G and H.

The center position of the conventional recorded round mark or the pit pattern (7) on the optical disk (5) is detected via the peak position in the graph of the values (D−2E+F) or (G′−H′).

In FIG. 3, the two first-degree diffraction light beams of the reading laser beam through the diffraction grating (4) are focused on the recording surface of the optical disk (5) as focus light spot (13).

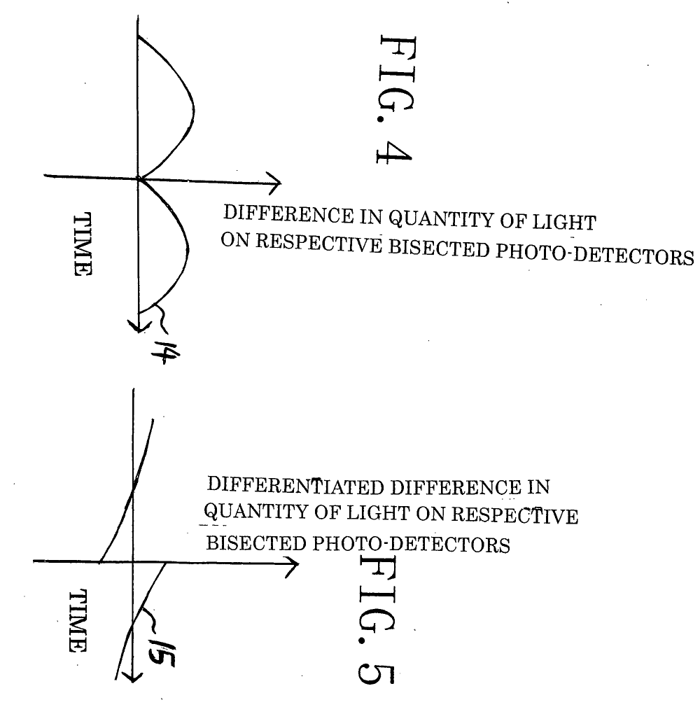

A graph obtained by means of the difference in the quantity of light on respective bisected photo-detector (11) is shown as a section (14) in FIG. 4 when the conventional recorded round mark or the pit pattern (7) at the center position of the focus light spot (13) moves in the direction of the recording track on the optical disk (5). A section (15) in FIG. 5 is therefore obtained from the differentiation of the section (14) in FIG. 4.

The three values G, H and I are obtained from the section (14) in FIG. 4 at three positions in the X-axis in a regular order. The value of (G−H) almost equals that of (H-I) when the signs (+/−) of the X values are all the same, however, the value of (G−H) is very different from that of (H−I) when the signs (+/−) of the X values are different.

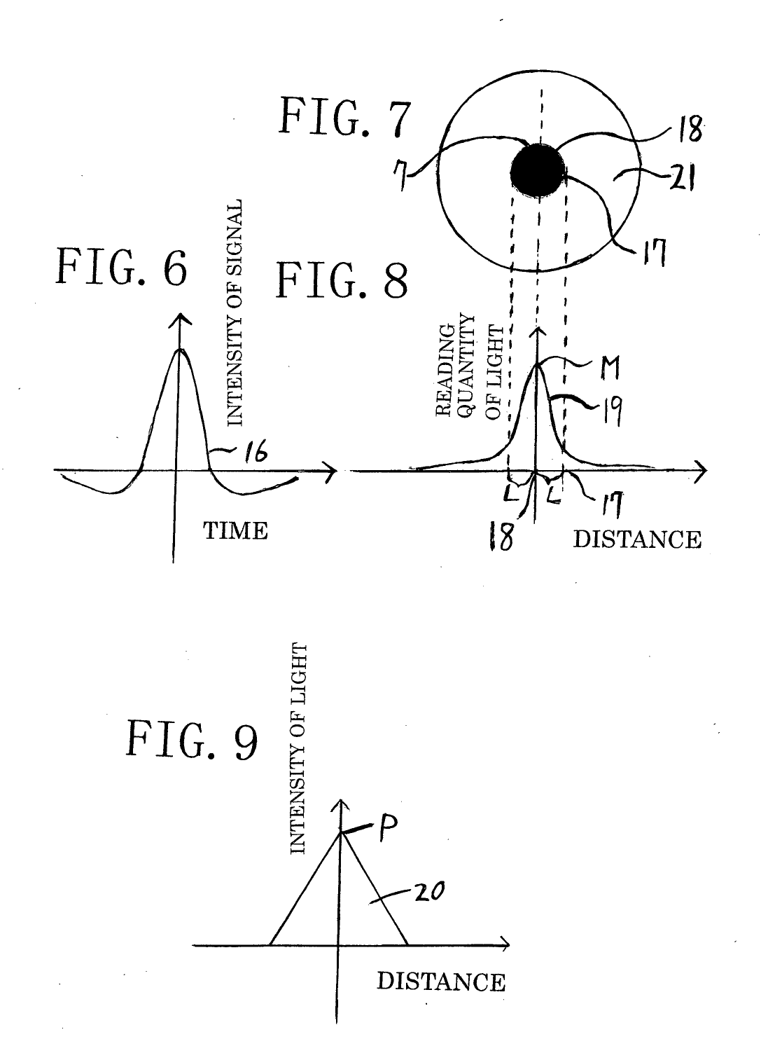

In FIG. 6, a graph (16) of the value (G−2H+1) has therefore a very sharp peak when the X value equals zero.

In FIG. 5, the graph (15) is not connected in the position where the X value equals zero, so there is a difference at this position.

The two values J and K are obtained from the graph (15) at two positions in regular order. The absolute value of (J−K) when the signs of the X values are different, is almost a constant. However, the shorter the interval between the two positions in the X-axis from which we obtain the two values J and K, the smaller the absolute value of (J−K) becomes when the signs of the X values are all the same. Therefore, a graph of the value of (J−K) is also shown as the graph (16) in FIG. 6, and has a sharp peak in the position where the X value equals zero.

The shorter the interval between the two positions in the X-axis, the sharper the peak of graph (16) becomes. This effect is generated because the graph (14) in FIG. 4 has a particular sharp point at the origin of the coordinate axes.

In FIGS. 7 and 8, the detected quantity of light for reading begins to increase greatly when the center position (18) of the focus light spot (21) for reading begins to get to the edge of the conventional recorded round mark or the pit pattern (7) with a radius L in the conventional reading method of an optical disk.

A graph (19) in FIG. 8 of the fluctuation in the reading quantity of light for the recorded round mark or the pit pattern (7) forms a peak with a height M when a center position (18) of the focus light spot (21) for reading gets to the center position of the conventional recorded round mark or the pit pattern (7) on the optical disk.

In the reading method of an optical disk in this invention, the image of the conventional recorded round mark or the pit pattern (7) on the optical disk (5) is focused on the bisected photo-detector (11) with a magnification N as almost a cone (20) in figure with a volume M and a height P in its light intensity distribution when the conventional recorded round mark or the pit pattern (7) on the optical disk (5) exists in the center position of the focus light spot (13) for reading as shown in FIG. 3.

In FIG. 8, the reading sensitivity of a conventional reading method for a conventional recorded round mark or a pit pattern (7) of the optical disk is given as the ratio of a varied quantity in the Y-axis to a minimal varied value ΔX in the X-axis: M/L·ΔX . . . (1)

In FIG. 9, the said volume M equals 1/3·π(NL)²p.

Therefore, P equals 3M/π(NL)² . . . (2)

The reading sensitivity of the reading method of an optical disk in this invention is shown as the difference in the quantity of light of respective bisected photo-detector (11) in N ΔX's time, which is considered as the volume of a trigonal prism with a base length 2 NL, a height P and a width 2 NΔX, while said cone (20) makes a parallel move for a NΔX from the origin of the coordinate axes.

The volume of this trigonal prism equals ½·2NL·3M/π(NL)²·2NΔX; ½·2NL·3M/π(NL)²·2NΔX equals 6M/πL·ΔX . . . (3)

Compared to conventional reading methods of an optical disk, the reading method of an optical disk in this invention has a higher conventional recorded round mark detection sensitivity or a higher pit pattern detection sensitivity because of equations (1) and (3).

The detected quantity of light of each of the bisected photo-detector (11) varies almost equally even in the presence of scratches, dust, and oil from fingers on the protection layer of the recording surface of the optical disk (5), outfocusing of reading focus light spot, tracking error, laser noise for reading and amplifier noise, etc.

Therefore, this makes a minimal error when detecting the center position of the conventional recorded round mark or the pit pattern (7) on the optical disk (5).

In FIGS. 3 and 6, the reading method of an optical disk in this invention enables the center position of each conventional recorded round mark or each pit pattern (7) to be read by the reading focus light spot (13) with a radius within a length between the center position of the conventional recorded round mark or the pit pattern (7) and the edge of its next conventional recorded round mark or its next pit pattern (7) on the optical disk (5).

It is therefore possible that the reading method of an optical disk in this invention can record a larger amount of information than conventional methods.

In FIG. 4, the reading method of an optical disk in this invention detects a particular point or a sharper point in the graph (14) of the difference in quantity of light of respective bisected photo-detector (11), resulting in separation of extremely high frequency components in graph (14).

The amplifier noise is also minimal through the separation of only extremely high frequency components or the least intense noise within it.

Since the tilting in the direction of a recording track of the optical disk (5) has an effect on the difference in the quantity of light of the bisected photo-detector (11), it is necessary that the reading laser beam be irradiated in a direction perpendicular to the recording track of the optical disk (5) with an irradiation-correction system.

Recording without the diffraction effect of the diffraction grating (4) is performed by using the electro-optic effect or the piezoelectric effect with a high-speed response.

While a few embodiments of this invention have been illustrated and described in detail, it is particularly understood that the invention is not limited thereto or thereby.

What is claimed is:

1. A reading method of an optical disk comprising: a photo-detection system which detects a difference in both sides of a divided focus light spot of the returned light from an optical disk; the obtainment of the center position of each conventional recorded mark or each pit pattern on the optical disk from the values obtained through the operation with the measurements of the difference in both sides of the divided focus light spot of the returned light from the optical disk subtracted once or more.

2. A reading method of an optical disk of claim 1, wherein three measurements which we can call Q, R and S are detected by the photo-detection system at regular time intervals and the center position of each conventional recorded mark or each pit pattern on the optical disk is obtained by the value (Q−2R+S).

3. A reading method of an optical disk of claim 1, wherein the two values T and U are obtained by differentiating the measurements in the photo-detection system and the center position of each conventional recorded mark or each pit pattern on the optical disk is obtained by the value (T−U).
